(19) United States
(12) Patent Application Publication
(10) Pub. No.: US 2020/0268593 A1
(43) Pub. Date: Aug. 27, 2020

(54) SILENT JADE MASSAGE COSMETIC ROLLER THAT CAN BE FREELY ASSEMBLED

(71) Applicant: Wenjie Yi, Shaoyang (CN)

(72) Inventor: Wenjie Yi, Shaoyang (CN)

(21) Appl. No.: 16/285,129

(22) Filed: Feb. 25, 2019

(51) Int. Cl. A61H 15/00; B06B 1/04

(52) U.S. Cl. CPC A61H 15/0085; A61H 2015/0014; B06B 1/045

(57) ABSTRACT

The invention disclosures a silent jade massage cosmetic roller that can be freely assembled, comprising a connecting rod, supports, massage rollers, wherein both two ends of the connecting rod are screwed to one end of a fixing bolt cap, the other end of the fixing bolt cap is screwed to the support comprising connecting shafts, a vibrating motor is provided in the massage roller, a shaft sleeve is arranged at both ends of the massage roller, and the shaft sleeve comprising wire connection holes is coupled with the connecting shaft, the connecting rod is provided with a stall switch and a charge hole, and a battery and a control chip are provided in the connecting rod. Compared with the prior art, the invention has the advantages of free assembly, low noise with vibration function, and is suitable for various facial forms.

### BACKGROUND OF THE INVENTION

### 1. Field of the Invention

The invention relates to the technical field of massage appliances, in particular, to a silent jade massage cosmetic roller that can be freely assembled.

### 2. Description of the Related Art

Many of the prior massagers are popular among people, especially some massagers used for eyes and face are very popular among female users, these kind of massagers usually comprise a handle for hand grasping, some handles are fixedly connected to massage roller at one end, the handle and the massage rollers are integrated and can not be disassembled, therefore, the massage rollers can not be replaced separately, with no flexible assembly and replacement, the prior massagers can not meet different needs.

### SUMMARY OF THE INVENTION

In order to solve the defects in structure and function of the prior massagers mentioned above, the invention provides a silent jade massage cosmetic roller that can be freely assembled which can be freely assembled, has vibration function with low noise, and is suitable for all the facial forms.

In order to solve above technical problems, the invention adopts the technical scheme: A silent jade massage cosmetic roller that can be freely assembled, comprising a connecting rod, supports, massage rollers, wherein both two ends of the connecting rod are screwed to one end of a fixing bolt cap, the other end of the fixing bolt cap is screwed to the support, connecting shafts are provided in the support, a vibrating motor is provided in the massage roller, a shaft sleeve is arranged at both ends of the massage roller, and the shaft sleeve is coupled with the connecting shaft, the shaft sleeve is provided with wire connection holes, the connecting rod is provided with a stall switch and a charge hole, and a battery and a control chip are provided in the connecting rod.

Compared with the prior art, the invention has the advantages that the massage rollers are rotatably connected to the connecting shafts inside the support by the shaft sleeves, which can improve the stability of the massage roller when rotating at the support, since the wires in the support are connected to the wire connection holes on the shaft sleeves, the connecting shafts have nothing around, which can avoid the friction between the support and the shaft sleeve, effectively avoid the generation of noise and refine the users' experience; the support is screwed to the fixing bolt cap and the fixing bolt cap is screwed to the connecting rod, which enables the massage cosmetic roller to be freely assembled; the massage roller on the support is removable, that is the massage roller on the support can be freely replaced and assembled to meet the needs of different facial forms; a vibrating motor is provided in the massage roller, which speeds up the contact frequency between the skin and the massage rollers to make the cosmetic effect better.

The invention serves as the improvement that a first magnetic element is provided in the fixing bolt cap, a second magnetic element is arranged on both ends of the connecting rod, the first magnetic element and the second magnetic element are magnetically connected.

The invention serves as the improvement that the massage rollers are composed of jade.

The invention serves as the improvement that wires are provided in the supports, the fixing bolt cap and the connecting rod, the wires in the supports are twisted with each other, and the wires are provided with interconnecting pieces.

The invention serves as the improvement that the stall switch is provided with three gears.

The invention serves as the improvement that a seal plate is arranged at the battery in the connecting rod and at both ends of the control chip, the seal plate is provided with through holes through which the wires pass.

### BRIEF DESCRIPTION OF THE DRAWINGS

FIG. 1 shows the explosive view of a silent jade massage cosmetic roller that can be freely assembled in the invention.

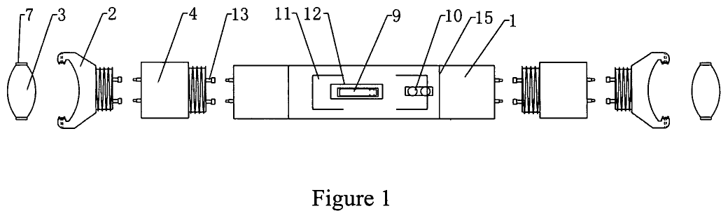

FIG. 2 shows the front view of a silent jade massage cosmetic roller that can be freely assembled in the invention.

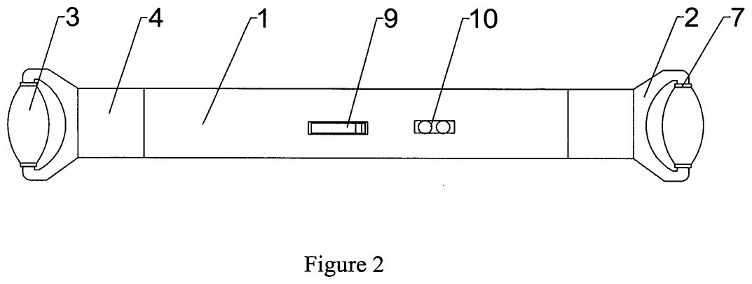

FIG. 3 describes a diagram of the internal structure of a silent jade massage cosmetic roller that can be freely assembled in the invention.

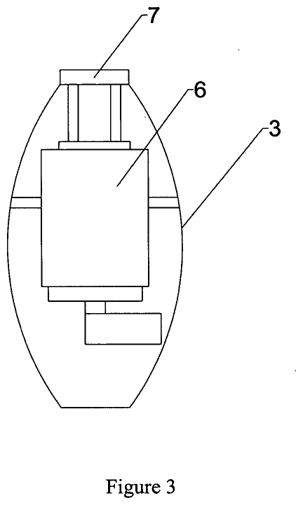

FIG. 4 describes a diagram of the support structure of a silent jade massage cosmetic roller that can be freely assembled in the invention.

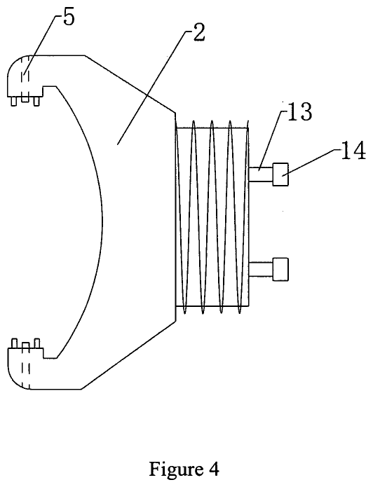

FIG. 5 describes a diagram of the shaft sleeve structure of a silent jade massage cosmetic roller that can be freely assembled in the invention.

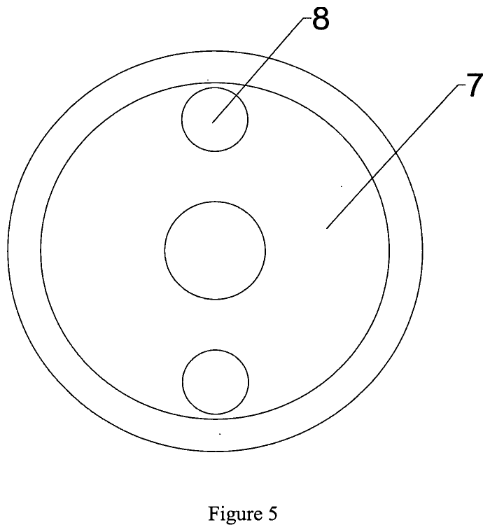

As shown in the accompanying drawings: 1 refers to connecting rod, 2 refers to supports, 3 refers to massage rollers, 4 refers to fixing bolt cap, 5 refers to connecting shaft, 6 refers to vibrating motor, 7 refers to shaft sleeve, 8 refers to wire connection holes, 9 refers to stall switch, 10 refers to charge hole, 11 refers to battery, 12 refers to refers to control chip, 13 refers to wires, 14 refers to interconnecting pieces, and 15 refers to seal plate.

### PREFERRED EMBODIMENTS OF THE INVENTION

The invention will be further described in detail below with reference to the accompanying drawings.

In the specific embodiments of the invention, a silent jade massage cosmetic roller that can be freely assembled, comprising a connecting rod 1, supports 2, massage rollers 3, wherein both two ends of the connecting rod are screwed to one end of a fixing bolt cap 4, the other end of the fixing bolt cap 4 is screwed to the support 2, connecting shafts 5 are provided in the support 2, a vibrating motor 6 is provided in the massage roller 3, a shaft sleeve 7 is arranged at both ends of the massage roller 3, and the shaft sleeve 7 is coupled with the connecting shaft 5, the shaft sleeve 7 is provided with wire connection holes 8, the connecting rod 1 is provided with a stall switch 9 and a charge hole 10, and a battery 11 and a control chip 12 are provided in the connecting rod.

A first magnetic element is provided in the fixing bolt cap 4, a second magnetic element is arranged on both ends of the connecting rod 1, the first magnetic element and the second magnetic element are magnetically connected, thereby the fixing bolt cap 4 and the connecting rod 1 are conveniently connected and fastened.

The massage rollers 3 are composed of jade, the application of jade massage can promote facial blood circulation, speed up metabolism and blood circulation, encourage skin regeneration, and accelerate skin-whitening and spot-fading.

Wires 13 are provided in the supports 2, the fixing bolt cap 4 and the connecting rod 1, the wires 13 in the supports 2 are twisted with each other, and the wires 13 are provided with interconnecting pieces 14 to facilitate the disassembly and assembly of the respective parts, the wires 13 in the support 2 are twisted, thereby the wires 13 may not be twisted off when the massage rollers 3 rotate.

The stall switch 9 is provided with three gears, thereby the massage cosmetic roller have three vibration positions to meet different needs of users.

A seal plate 15 is arranged at the battery 11 in the connecting rod 1 and at both ends of the control chip 12, the seal plate 15 is provided with through holes through which the wires pass, and can avoid the dust entering into the battery 11 or control chip 12 when placing and disassembling which may cause adverse effect on circuit.

The working principle of the invention: when using the silent jade massage cosmetic roller that can be freely assembled, different massage rollers can be changed according to the user's facial form, inserting the wires in the support into the wire connection holes on the shaft sleeves, the massage rollers are rotatably connected to the connecting shafts inside the support by the shaft sleeve on both sides thereof, the massage rollers are connected to the connecting shafts inside the support by the shaft sleeves and wires are connected around the connecting shaft, thereby the contact surface between the shaft sleeve and the support is small, and the generated friction is small which can avoid the generation of noise. The wires in the support are connected to the wires in the fixing bolt cap by the interconnecting pieces, the support is screwed to the fixing bolt cap, the wires in the fixing bolt cap are connected to the wires in the connecting rod by the interconnecting pieces, the fixing bolt cap is screwed to the connecting rod, thereby the respective parts of the massage cosmetic roller can be detachably cleaned. A vibrating motor is provided in the massage roller, thereby the massage rollers generate vibrations and speed up the contact frequency between the skin and the massage rollers to make the cosmetic effect better, and the vibration frequency can be adjusted by the stall switch on the connecting rod. A battery is provided in the connecting rod, the battery is electrically connected to the charge hole on the connecting rod, thereby the battery may not need to be removed frequently. A seal plate is arranged at the battery in the connecting rod and at both ends of the control chip, which can avoid the dust entering which may cause adverse effect on circuit.

The invention and embodiments thereof have been described above, and the description is not limited thereto, only one embodiment of the invention is shown in the accompanying drawings, and the actual structure is not limited thereto. In conclusion, the similar structures and embodiments with the technical scheme of the invention, which are designed by the general skilled person in the art inspired by the invention, without creativity and without departing from the spirit of the invention, should be included in the protection scope of the invention.

1. A silent jade massage cosmetic roller that can be freely assembled, comprising a connecting rod (1), supports (2), massage rollers (3), wherein both two ends of the connecting rod are screwed to one end of a fixing bolt cap (4), the other end of the fixing bolt cap (4) is screwed to the support (2), connecting shafts (5) are provided in the support (2), a vibrating motor (6) is provided in the massage roller (3), a shaft sleeve (7) is arranged at both ends of the massage roller (3), and the shaft sleeve (7) is coupled with the connecting shaft (5), the shaft sleeve (7) is provided with wire connection holes (8), the connecting rod (1) is provided with a stall switch (9) and a charge hole (10), and a battery (11) and a control chip (12) are provided in the connecting rod.

2. The silent jade massage cosmetic roller that can be freely assembled of claim 1, wherein a first magnetic element is provided in the fixing bolt cap (4), a second magnetic element is arranged on both ends of the connecting rod (1), the first magnetic element and the second magnetic element are magnetically connected.

3. The silent jade massage cosmetic roller that can be freely assembled of claim 1, wherein the massage rollers (3) are composed of jade.

4. The silent jade massage cosmetic roller that can be freely assembled of claim 1, wherein wires (13) are provided in the supports (2), the fixing bolt cap (4) and the connecting rod (1), the wires (13) in the supports (2) are twisted with each other, and the wires (13) are provided with interconnecting pieces (14).

5. The silent jade massage cosmetic roller that can be freely assembled of claim 1, wherein the stall switch (9) is provided with three gears.

6. The silent jade massage cosmetic roller that can be freely assembled of claim 1, wherein a seal plate (15) is arranged at the battery (11) in the connecting rod (1) and at both ends of the control chip (12), the seal plate (15) is provided with through holes through which the wires pass.
